(19) United States
(12) Patent Application Publication
(10) Pub. No.: US 2019/0203622 A1
(43) Pub. Date: Jul. 4, 2019

(54) CONTROL APPARATUS AND CONTROL METHOD FOR INTERNAL COMBUSTION ENGINE

(71) Applicant: HITACHI AUTOMOTIVE SYSTEMS, LTD., Hitachinaka-shi, Ibaraki (JP)

(72) Inventor: Takuya HARUGUCHI, Isesaki-shi, Gunma (JP)

(73) Assignee: HITACHI AUTOMOTIVE SYSTEMS, LTD., Hitachinaka-shi, Ibaraki (JP)

(21) Appl. No.: 16/334,334

(22) PCT Filed: Feb. 23, 2018
(86) PCT No.: PCT/JP2018/006722

§ 371 Date: Mar. 18, 2019

(30) Foreign Application Priority Data
Mar. 22, 2017 (JP) 2017-055509

(51) Int. Cl. F01N 3/20; F01N 13/00; F02D 41/14

(52) U.S. Cl. CPC F01N 3/20; F01N 13/008; F02D 41/1444; F01N 2550/02; F01N 2560/027; F01N 2560/026; F01N 2570/04

(57) ABSTRACT

A control apparatus and a control method for an internal combustion engine of the present invention integrates an operating time in a state in which temperature TCAT of an exhaust gas purification catalyst is lower than a first temperature, to obtain first integrated time IT1, senses oxygen storage capacity OSC of the exhaust gas purification catalyst, and has a regeneration treatment of sulfur poisoning carried out when first integrated time IT1 exceeds first time THT1 and oxygen storage capacity OSC falls below first capacity OSC1, and furthermore, integrates an operating time in a state in which temperature TCAT of the exhaust gas purification catalyst is higher than second temperature TCAT2, to obtain second integrated time IT2, and has a regeneration treatment of oxidation poisoning carried out when second integrated time IT2 exceeds second time THT2.

### TECHNICAL FIELD

The present invention relates to control apparatuses and to control methods for internal combustion engines, and more specifically, relates to techniques for detecting poisoning of an exhaust gas purification catalyst so as to carry out poisoned catalyst regeneration treatment.

### BACKGROUND ART

Patent Document 1 discloses an exhaust gas purification apparatus for an internal combustion engine in which, in order to carry out just enough poisoning regeneration treatments of an exhaust gas purification catalyst, coping with the difference in sulfur concentration due to the difference in fuel properties, to prevent reduced fuel economy and thermal degradation of the catalyst, travel distance HMILE with high-octane gasoline and travel distance RMILE with regular gasoline are separately integrated, and a poisoning regeneration request is generated when HMILE+RMILE becomes greater than or equal to a threshold value.

### REFERENCE DOCUMENT LIST

### Patent Document

Patent Document 1: JP 2004-132230 A

### SUMMARY OF THE INVENTION

### Problem to be Solved by the Invention

When detecting sulfur poisoning of an exhaust gas purification catalyst, if sulfur poisoning is detected based on an integrated value of a travel distance of a vehicle on which the internal combustion engine is mounted, an operating time of an internal combustion engine, or the like, sulfur poisoning cannot be detected with high accuracy, because the sulfur concentration varies even with the same regular gasoline. Thus, there is a possibility that a poisoned catalyst regeneration treatment will fail to be carried out even though the catalyst is actually poisoned with sulfur, and the exhaust gas purification catalyst remains poisoned.

Here, in order to prevent the exhaust gas purification catalyst from remaining poisoned, if the timing to carry out the poisoning regeneration treatment based on the travel distance, operating time, or the like, is set earlier, there may be a problem in that an excess poisoning regeneration treatment caused thereby might decrease fuel economy performance.

The present invention has been made in view of the above problems, and an object of the present invention is to provide a control apparatus and a control method for an internal combustion engine, capable of accurately detect poisoning of an exhaust gas purification catalyst, and thus, capable of preventing the exhaust gas purification catalyst from remaining poisoned and a poisoning regeneration treatment from being excessively carried out.

### Means for Solving the Problem

According to an aspect, a control apparatus of an internal combustion engine of the present invention is a control apparatus for an internal combustion engine provided with an exhaust gas purification catalyst in an exhaust pipe, comprising:

a first integration section that integrates an operating time of the internal combustion engine operated in a state in which a temperature of the exhaust gas purification catalyst is lower than a first temperature, to obtain a first integrated time;

a capacity sensing section that senses an oxygen storage capacity of the exhaust gas purification catalyst;

a first poisoning detection section that detects poisoning of the exhaust gas purification catalyst, when the first integrated time exceeds a first time and the oxygen storage capacity falls below a first capacity; and

a first poisoning regeneration section that carries out a poisoning regeneration treatment that increases the temperature of the exhaust gas purification catalyst, when the first poisoning detection section detects the poisoning of the exhaust gas purification catalyst.

Furthermore, according to an aspect, a control method for an internal combustion engine of the present invention is a control method for an internal combustion engine provided with an exhaust gas purification catalyst in an exhaust pipe, comprising:

integrating an operating time of the internal combustion engine operated in a state in which a temperature of the exhaust gas purification catalyst is lower than a first temperature, to obtain a first integrated time;

sensing an oxygen storage capacity of the exhaust gas purification catalyst; and

carrying out a poisoning regeneration treatment that increases the temperature of the exhaust gas purification catalyst, when the first integrated time exceeds a first time and the oxygen storage capacity falls below a first capacity.

### Effects of the Invention

According to the invention, it is possible to accurately carry out a poisoning regeneration treatment in a poisoned exhaust gas purification catalyst, and this makes it possible to prevent the poisoning regeneration treatment from being excessively carried out and the exhaust gas purification catalyst from remaining poisoned.

### BRIEF DESCRIPTION OF THE DRAWINGS

FIG. 1 is a system configuration view of an internal combustion engine according to an embodiment of the present invention.

FIG. 2 is a flowchart illustrating a sensing process of oxygen storage capacity OSC of an exhaust gas purification catalyst according to the embodiment of the present invention.

FIG. 3 is a flowchart illustrating an integrating process of first integrated time IT1 and second integrated time IT2 according to the embodiment of the present invention.

FIG. 4 is a diagram illustrating the relationship between catalyst temperature TCAT of the exhaust gas purification catalyst and integration coefficient ICO2 according to the embodiment of the present invention.

FIG. 5 is a diagram illustrating the relationship between catalyst temperature TCAT of the exhaust gas purification catalyst and integration coefficient ICO1 according to the embodiment of the present invention.

FIG. 6 is a flowchart illustrating an oxidation poisoning regeneration treatment and a sulfur poisoning regeneration treatment according to the embodiment of the present invention.

FIG. 7 is a diagram illustrating the relationship between an air-fuel ratio and second integrated time IT2 according to the embodiment of the present invention.

FIG. 8 is a timing diagram illustrating a pattern of carrying out the oxidation poisoning regeneration treatment and the sulfur poisoning regeneration treatment according to the embodiment of the present invention.

### MODE FOR CARRYING OUT THE INVENTION

Hereinbelow, an embodiment of the present invention will be described.

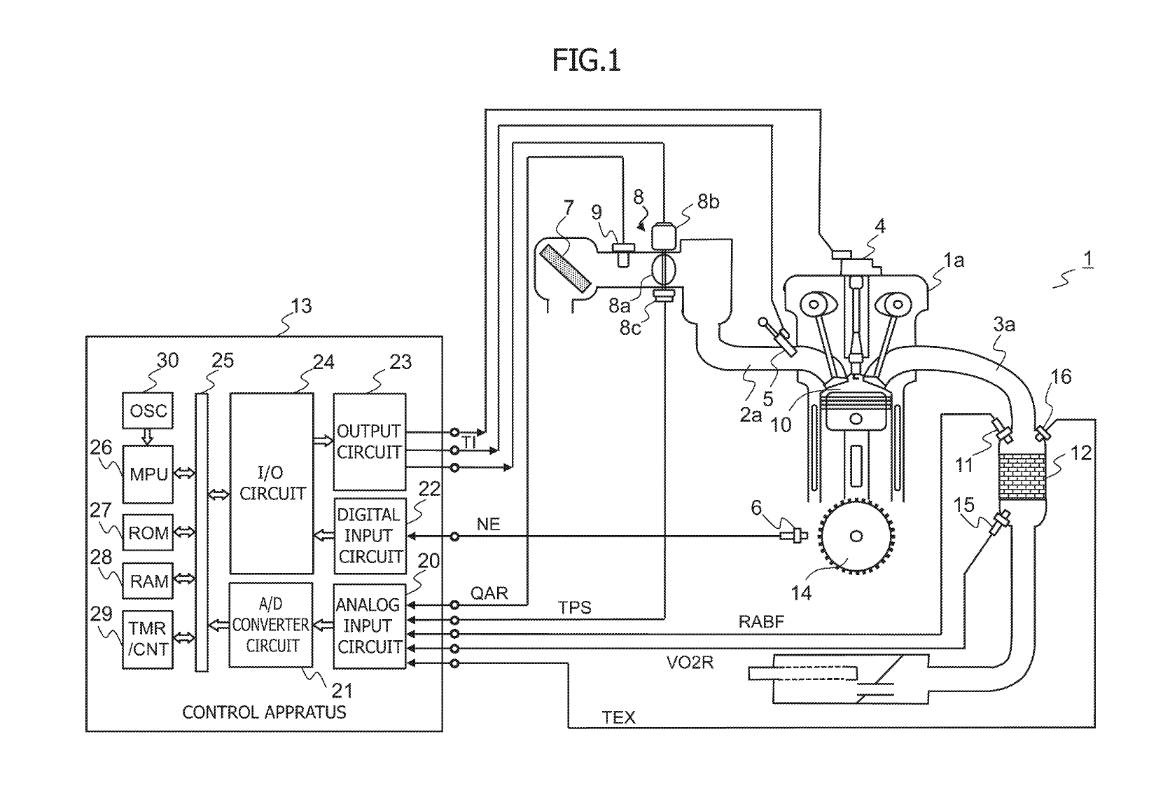

FIG. 1 is a diagram illustrating an aspect of an internal combustion engine to which a control apparatus and a control method according to the present invention are applied.

An internal combustion engine 1 illustrated in FIG. 1 is a spark ignition gasoline engine for a vehicle, and has an engine body 1a on which an ignition device 4, a fuel injection device 5, a revolution speed sensing device 6, and the like, are mounted.

Air taken in through an air cleaner 7 is adjusted in flow rate by a throttle valve 8a of an electric throttle 8, and then, is mixed with a fuel injected into an intake passage 2a from the fuel injection device 5, and the mixture is drawn into a combustion chamber 10.

Electric throttle 8 is a device that drives throttle valve 8a to open and close by a throttle motor 8b, and is provided with a throttle opening sensor 8c that outputs throttle valve opening degree signal TPS.

A flow rate sensing device 9 is arranged upstream of electric throttle 8, and flow rate sensing device 9 measures intake air flow rate QAR of internal combustion engine 1.

In exhaust passage 3a, an exhaust gas purification catalyst 12 having the oxygen occlusion capability, such as a three-way catalyst, is provided. Exhaust gas of internal combustion engine 1 is purified by exhaust gas purification catalyst 12, and then, is discharged into the atmosphere.

In exhaust passage 3a on the upstream side of exhaust gas purification catalyst 12, there are disposed an air-fuel ratio sensor 11 that outputs detection signal RABF corresponding to an exhaust gas air-fuel ratio, and an exhaust gas temperature sensor 16 that senses exhaust gas temperature TEX (° C.) at an inlet of exhaust gas purification catalyst 12.

In exhaust passage 3a on the downstream side of exhaust gas purification catalyst 12, there is disposed an oxygen sensor 15 that outputs detection signal VO2R indicative of rich and lean of the exhaust gas air-fuel ratio with respect to a theoretical air-fuel ratio.

In place of oxygen sensor 15, an air-fuel ratio sensor that linearly senses the exhaust gas air-fuel ratio may be disposed in exhaust passage 3a on the downstream side of the exhaust gas purification catalyst 12.

By a fuel supply device (not illustrated), a fuel in a fuel tank is adjusted to have a predetermined pressure and is supplied to fuel injection device 5.

A control apparatus 13 receives intake air flow rate QAR measured by flow rate sensing device 9, rotational angle signal NE of a crankshaft output by revolution speed sensing device 6 based on a protrusion of a ring gear 14, and the like, and, based on these, calculates fuel injection pulse width TI, to control fuel injection device 5 based on fuel injection pulse width TI.

Furthermore, control apparatus 13 receives detection signal RABF of air-fuel ratio sensor 11 and detection signal VO2R of oxygen sensor 15, and performs a feedback control of the air-fuel ratio in which fuel injection pulse width TI is corrected such that the air-fuel ratio of internal combustion engine 1 approaches a target value.

Furthermore, control apparatus 13 controls the ignition timing of ignition device 4 and the opening degree of throttle valve 8a by outputting manipulated variables to ignition device 4 and electric throttle 8, so as to control the operation of internal combustion engine 1.

Control apparatus 13 is provided with an analog input circuit 20, an A/D converter circuit 21, a digital input circuit 22, an output circuit 23, and an I/O circuit 24, to input and output various data, such as measurement results of various sensors and manipulated variables output to various devices.

In addition, control apparatus 13 is provided with a microcomputer including an MPU 26, a ROM 27, and a RAM 28 to execute a calculating process of data.

To analog input circuit 20, intake air flow rate QAR measured by flow rate sensing device 9, throttle valve opening degree signal TPS sensed by throttle opening sensor 8c, detection signal RABF of air-fuel ratio sensor 11, and detection signal VO2R of oxygen sensor 15 are input.

Intake air flow rate QAR, throttle valve opening degree signal TPS, detection signal RABF, and detection signal VO2R input to analog input circuit 20, are supplied to A/D converter circuit 21, and converted into digital signals. The digital signals are output to a bus 25.

Rotational angle signal NE of the crankshaft input to digital input circuit 22 is output to bus 25 via I/O circuit 24.

To bus 25, MPU 26, ROM 27, RAM 28, a timer/counter (TMR/CNT) 29, and the like, are connected. This allows data to be exchanged via bus 25.

To MPU 26, a clock signal is supplied from a clock generator 30, and various calculations and processes are executed in synchronization with the clock signal.

For example, ROM 27 is composed of an EEPROM that is capable of erasing and rewriting data, and stores a program, setting data, initial value, and the like, for operating control apparatus 13. Such stored information is read into RAM 28 and MPU 26 via bus 25 in response to the turning on of an engine switch, or the like.

RAM 28 is used as a work area and is adapted to temporarily store calculation results and processing results obtained by MPU 26. Timer/counter 29 is used for measurement of time, measurement of number of times of various kinds, and the like.

Calculation results and processing results obtained by MPU 26 are output to bus 25 and are supplied from output circuit 23 to ignition device 4, fuel injection device 5, electric throttle 8, and the like, via I/O circuit 24.

Furthermore, control apparatus 13 has a function, as software, of detecting presence or absence of poisoning of exhaust gas purification catalyst 12, and having a poisoning regeneration treatment carried out when an occurrence of poisoning is detected. Here, poisoning of exhaust gas purification catalyst 12 detected by control apparatus 13 includes oxidation poisoning in which oxygen is left adsorbed on the noble metal, and sulfur poisoning in which sulfur is adsorbed on the surface of the noble metal.

In other words, control apparatus 13 has, as software, a function serving as a first poisoning detection section that detects sulfur poisoning of exhaust gas purification catalyst 12, a function serving as a first poisoning regeneration section that has a sulfur poisoning regeneration treatment carried out when sulfur poisoning is detected, a function serving as a second poisoning detection section that detects oxidation poisoning of exhaust gas purification catalyst 12, and a function serving as a second poisoning regeneration section that has an oxidation poisoning regeneration treatment carried out when oxidation poisoning is detected.

In order to detect sulfur poisoning and oxidation poisoning, control apparatus 13 integrates the operating time of internal combustion engine 1 operated in a state in which temperature TCAT of exhaust gas purification catalyst 12 is lower than first temperature TCAT1, to obtain first integrated time IT1, and also integrates the operating time of internal combustion engine 1 operated in a state in which temperature TCAT of exhaust gas purification catalyst 12 is higher than second temperature TCAT2, to obtain second integrated time IT2, and furthermore, control apparatus 13 senses oxygen storage capacity OSC (O₂ storage capacity) of exhaust gas purification catalyst 12.

Then, when first integrated time IT1 exceeds first time THT1 and oxygen storage capacity OSC falls below first capacity OSC1, control apparatus 13 detects sulfur poisoning of exhaust gas purification catalyst 12, and has a sulfur poisoning regeneration treatment that increases the temperature of exhaust gas purification catalyst 12, carried out.

Furthermore, when second integrated time IT2 exceeds second time THT2, control apparatus 13 detects oxidation poisoning of exhaust gas purification catalyst 12, and has an oxidation poisoning regeneration treatment carried out that changes the air-fuel ratio of internal combustion engine 1 to be richer.

Hereinbelow, the processes for detecting sulfur poisoning and oxidation poisoning, and the poisoning regeneration treatments carried out by control apparatus 13, will be described in detail.

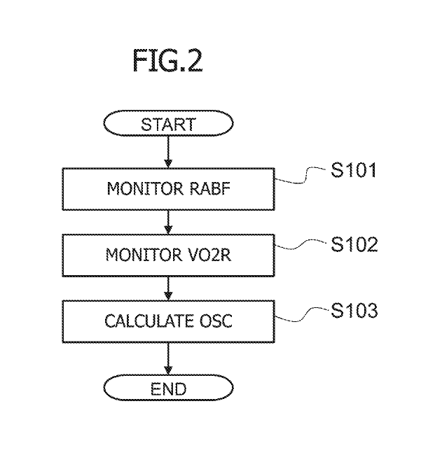

A flowchart of FIG. 2 illustrates an aspect of the sensing process of oxygen storage capacity OSC (g) performed by control apparatus 13. For example, the process indicated in the flowchart of FIG. 2 is interruptedly executed at predetermined time intervals by control apparatus 13.

First, in step S101, control apparatus 13 executes a monitoring process of detection signal RABF to sense the output characteristics, such as the number of times of inversion and the cycle of detection signal RABF of air-fuel ratio sensor 11 during an air-fuel ratio feedback control.

Next, in step S102, control apparatus 13 executes a monitoring process of detection signal VO2R to sense the output characteristics, such as the number of times of inversion and the cycle of detection signal VO2R of oxygen sensor 15 during the air-fuel ratio feedback control.

Then, in step S103, control apparatus 13 calculates the ratio or the difference between the number of times of inversion or cycles of detection signal RABF and the number of times of inversion or cycles of detection signal VO2R. Based on the obtained ratio or difference, control apparatus 13 calculates oxygen storage capacity OSC (or data correlating with oxygen storage capacity OSC) of exhaust gas purification catalyst 12.

Exhaust gas purification catalyst 12 has the oxygen storage capability so that exhaust gas purification catalyst 12 occludes oxygen when exhaust gas flowing therein is a lean gas, and releases occluded oxygen when exhaust gas flowing therein is switched to a rich gas. This causes a delay in switching of the exhaust gas air-fuel ratio to be rich on the downstream side of exhaust gas purification catalyst 12. This delay increases as oxygen storage capacity OSC increases. Therefore, using this characteristic, control apparatus 13 senses oxygen storage capacity OSC of exhaust gas purification catalyst 12.

It should be noted that the calculating process of oxygen storage capacity OSC is not limited to the abovementioned process that is based on the difference or ratio, and control apparatus 13 may have a well-known OSC calculation function.

For example, control apparatus 13 may forcibly control the air-fuel ratio of exhaust gas flowing into exhaust gas purification catalyst 12 to be rich or lean with respect to the theoretical air-fuel ratio, and obtain a time period during which exhaust gas purification catalyst 12 continues to release oxygen from a state of maximum oxygen occlusion amount or a time period during which exhaust gas purification catalyst 12 continues to occlude oxygen from a state of minimum oxygen occlusion amount, as data corresponding to oxygen storage capacity OSC.

Furthermore, control apparatus 13 may obtain an integrated value of an oxygen occluded amount and an oxygen release amount per calculation period in a time period during which exhaust gas purification catalyst 12 continues occluding or releasing oxygen, as data corresponding to oxygen storage capacity OSC.

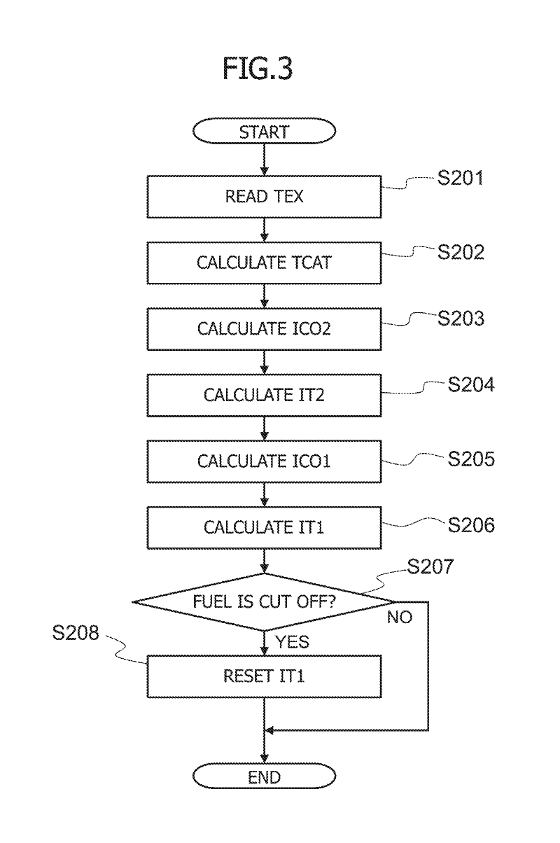

A flowchart of FIG. 3 illustrates an aspect of the calculating process of first integrated time IT1 and second integrated time IT2 executed by control apparatus 13.

For example, the process indicated in the flowchart of FIG. 3 is interruptedly executed at predetermined time intervals by control apparatus 13.

In step S201, control apparatus 13 reads exhaust gas temperature TEX at the inlet of exhaust gas purification catalyst 12 sensed by temperature sensor 16. In the next step S202, control apparatus 13 estimates temperature TCAT of exhaust gas purification catalyst 12 based on exhaust gas temperature TEX.

In the estimating process of temperature TCAT of exhaust gas purification catalyst 12 based on exhaust gas temperature TEX, control apparatus 13 may estimate temperature TCAT assuming that the change in temperature TCAT follows the change in exhaust gas temperature TEX with a predetermined delay, for example.

Furthermore, if internal combustion engine 1 includes no exhaust gas temperature sensor 16, control apparatus 13 may estimate temperature TCAT based on the operating conditions of internal combustion engine 1, such as engine revolution speed, engine load, total fuel consumption, exhaust gas flow rate, outside air temperature, cooling water temperature, and lubricant oil temperature.

Furthermore, internal combustion engine 1 may be provided with a catalyst temperature sensor that senses the internal temperature of exhaust gas purification catalyst 12, and control apparatus 13 may obtain temperature TCAT from the output signal of the catalyst temperature sensor.

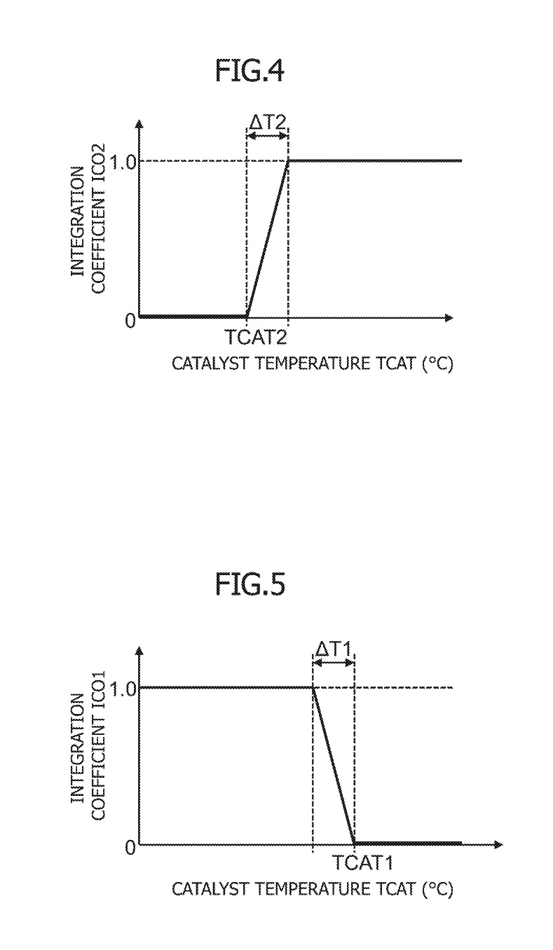

Next, in step S203, control apparatus 13 sets integration coefficient ICO2 based on temperature TCAT of exhaust gas purification catalyst 12. Integration coefficient ICO2 is used to obtain second integrated time IT2, which is an integrated value of the operating time of internal combustion engine 1 operated in a state in which temperature TCAT of exhaust gas purification catalyst 12 is higher than second temperature TCAT2 (see FIG. 4).

As will be described below, integration coefficient ICO2 is a correction coefficient that is multiplied with a calculation period of second integrated time IT2 in a calculating process obtaining a present value by adding the calculation period of second integrated time IT2 to a previous value of second integrated time IT2. If integration coefficient ICO2 is zero, second integrated time IT2 is held at the previous value. If integration coefficient ICO2 is 1, the calculation period is added as it is to the previous value, and the addition result is set as the present value of second integrated time IT2.

Furthermore, second temperature TCAT2 is a lower limit temperature in a high temperature range that causes oxidation poisoning in which oxygen is left adsorbed on the noble metal of exhaust gas purification catalyst 12, to progress, and second temperature TCAT2 is set to a temperature of about 700° C. to 800° C., for example.

In step S203, when temperature TCAT of exhaust gas purification catalyst 12 is less than or equal to second temperature TCAT2, control apparatus 13 sets integration coefficient ICO2 to zero, to stop the integration of second integrated time IT2 (see FIG. 4).

On the other hand, control apparatus 13 gradually increases integration coefficient ICO2 from zero as temperature TCAT of exhaust gas purification catalyst 12 becomes higher than second temperature TCAT2, and sets integration coefficient ICO2 to 1 when temperature TCAT of exhaust gas purification catalyst 12 becomes higher than second temperature TCAT2 by predetermined temperature ΔT2 (for example, ΔT2=50° C.) or more (see FIG. 4). That is, in the temperature range in which temperature TCAT of exhaust gas purification catalyst 12 is slightly higher than second temperature TCAT2, in other words, in the temperature range close to the lower temperature within the temperature range in which oxidation poisoning is expected to progress (i.e., TCAT2 to TCAT2+ΔT2), it is estimated that the progress of oxidation poisoning will be slower than in the higher temperature range.

Therefore, in the temperature range higher than or equal to second temperature TCAT2, control apparatus 13 decreases the weight of the operating time as temperature TCAT of exhaust gas purification catalyst 12 is closer to second temperature TCAT2, and in contrast, control apparatus 13 increases the weight of the operating time when temperature TCAT of exhaust gas purification catalyst 12 is sufficiently higher than second temperature TCAT2.

It should be noted that integration coefficient ICO2 may be set to zero in a temperature range lower than second temperature TCAT2, and may be set to 1 in a temperature range higher than second temperature TCAT2.

After setting integration coefficient ICO2 in step S203, control apparatus 13 proceeds to step S204 and executes an updating process of second integrated time 11′2.

Control apparatus 13 adds the value obtained by multiplying execution period PT (ms) of this routine by integration coefficient ICO2, to second integrated time IT2(n−1) at the time of the previous execution of this routine, and sets the resultant to be present value IT2(n) of second integrated time IT2 (IT2(n)=IT2(n−1)+PT×ICO2).

Second integrated time IT2 calculated in accordance with the above equation is the sum of the operating time of internal combustion engine 1 operated in a state in which temperature TCAT of exhaust gas purification catalyst 12 is higher than second temperature TCAT2, in other words, in the temperature conditions under which oxidation poisoning of exhaust gas purification catalyst 12 progresses.

Furthermore, in step S205, control apparatus 13 sets integration coefficient ICO1 based on temperature TCAT of exhaust gas purification catalyst 12. Integration coefficient ICO1 is used to obtain first integrated time IT1, which is an integrated value of the operating time of internal combustion engine 1 operated in a state in which temperature TCAT of exhaust gas purification catalyst 12 is lower than first temperature TCAT1 (see FIG. 5).

First temperature TCAT1 is an upper limit temperature of a low to middle temperature range in which sulfur poisoning progresses in exhaust gas purification catalyst 12, and is set to a temperature of about 750° C. to 850° C., for example.

In step S205, when temperature TCAT of exhaust gas purification catalyst 12 is higher than or equal to first temperature TCAT1, control apparatus 13 sets integration coefficient ICO1 to zero, to stop the integration of first integrated time IT1 (see FIG. 5).

On the other hand, control apparatus 13 gradually increases integration coefficient ICO1 from zero as temperature TCAT of exhaust gas purification catalyst 12 becomes lower than first temperature TCAT1, and sets integration coefficient ICO1 to 1 when temperature TCAT is lower than or equal to a temperature that is lower than first temperature TCAT1 by predetermined temperature ΔT1 (for example, ΔT1=50° C.) (see FIG. 5).

That is, in the temperature range in which temperature TCAT of exhaust gas purification catalyst 12 is slightly lower than first temperature TCAT1, in other words, in the temperature range closer to the high temperature within the temperature range in which sulfur poisoning is expected to progress (i.e. TCAT1−ΔT1 to TCAT1), it is estimated that the progress of sulfur poisoning will be slower than in the lower temperature range.

Therefore, in the temperature range lower than or equal to first temperature TCAT1, control apparatus 13 decreases the weight of the operating time as temperature TCAT of exhaust gas purification catalyst 12 is closer to first temperature TCAT1, and in contrast, control apparatus 13 increases the weight of the operating time when temperature TCAT of exhaust gas purification catalyst 12 is within a temperature range sufficiently lower than first temperature TCAT1.

It should be noted that integration coefficient ICO1 may be set to zero in a temperature range higher than first temperature TCAT1, and may be set to 1 in a temperature range lower than first temperature TCAT1.

After setting integration coefficient ICO2 in step S205, control apparatus 13 proceeds to step S206 and executes an updating process of first integrated time IT1.

Control apparatus 13 adds the value obtained by multiplying execution period PT (ms) of this routine by integration coefficient ICO1, to first integrated time IT1(n−1) at the time of the previous execution of this routine, and sets the resultant to be present value IT1(n) of first integrated time IT1 (IT1(n)=IT1(n−1)+PT×ICO1).

First integrated time IT1 calculated in accordance with the above equation is the sum of the operating time of internal combustion engine 1 operated in a state in which temperature TCAT of exhaust gas purification catalyst 12 is lower than first temperature TCAT1, in other words, in the temperature conditions under which sulfur poisoning of exhaust gas purification catalyst 12 progresses.

Next, control apparatus 13 proceeds to step S207, in which control apparatus 13 determines whether a fuel cutoff has been performed for predetermined time FCT or more in a state in which temperature TCAT of exhaust gas purification catalyst 12 is higher than criterion temperature SCTHT.

The fuel cutoff is a process in which control apparatus 13 temporarily stops fuel injection by fuel injection device 5 during a deceleration operation of internal combustion engine 1, or the like.

Furthermore, criterion temperature SCTHT is the lowest temperature in a high-temperature range in which sulfur integrated in exhaust gas purification catalyst 12 is removed in a short time as an exhaust gas with the maximum lean air-fuel ratio flows into exhaust gas purification catalyst 12 by fuel cutoff. Criterion temperature SCTHT may be set, for example, to about 750° C. to 850° C., and criterion temperature SCTHT may be equal to first temperature TCAT1.

Predetermined time FCT is a time estimated until substantial completion of the removal of sulfur integrated in exhaust gas purification catalyst 12, caused by exposure of exhaust gas purification catalyst 12 to a high temperature oxidizing atmosphere, when the fuel cutoff is performed under temperature conditions higher than criterion temperature SCTHT. For example, predetermined time FCT is set to about 8 seconds to 10 seconds.

That is, when the fuel cutoff is performed for predetermined time FCT or more in a state in which temperature TCAT of exhaust gas purification catalyst 12 is higher than criterion temperature SCTHT, control apparatus 13 estimates that sulfur integrated in exhaust gas purification catalyst 12 has been removed, and proceeds to step S208, in which control apparatus 13 resets first integrated time IT1 for determining the progress of sulfur poisoning, to zero.

This makes it possible to prevent control apparatus 13 from continuing updating first integrated time IT1 and thus to prevent erroneous detection of the progress of sulfur poisoning in exhaust gas purification catalyst 12, despite the fact that the fuel cutoff by which the sulfur integrated in exhaust gas purification catalyst 12 is removed has been carried out.

It should be noted that even in a case in which fuel cutoff execution duration under the temperature condition higher than criterion temperature SCTHT falls below predetermined time FCT, control apparatus 13 may estimate that sulfur has been removed when the fuel cutoff is repeated a plurality of times within a given time period and when total fuel cutoff time period exceeds a set time period, and control apparatus 13 may reset first integrated time IT1 to zero.

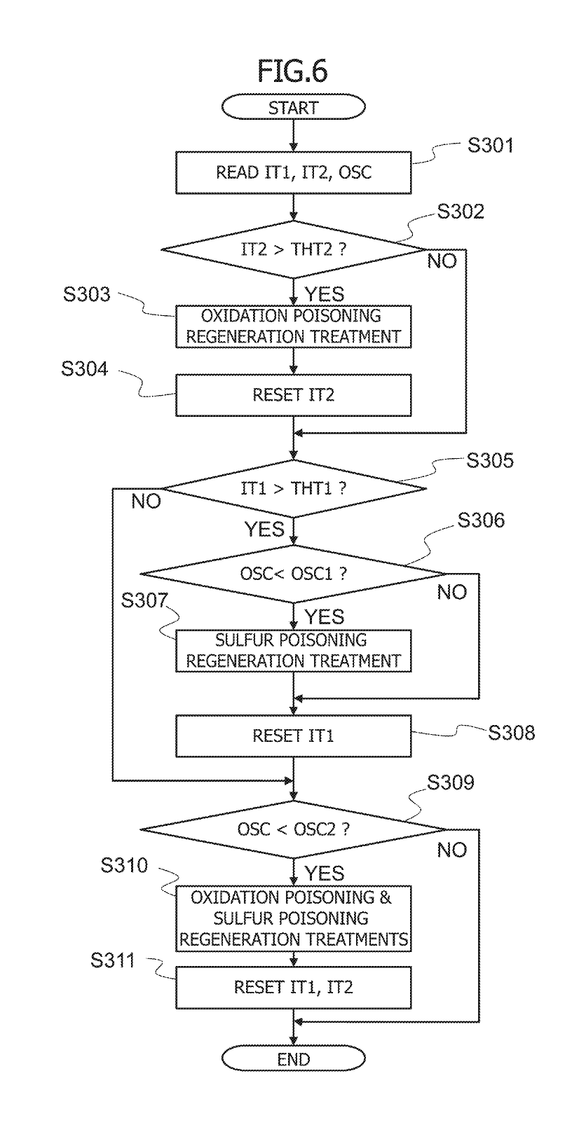

A flowchart of FIG. 6 illustrates an aspect of the detecting process of sulfur poisoning and oxidation poisoning and the process to have the poisoning regeneration treatment carried out, executed by control apparatus 13.

In the poisoning detecting process indicated in the flowchart of FIG. 6, control apparatus 13 uses oxygen storage capacity OSC obtained by the process indicated in the flowchart of FIG. 2, and first integrated time IT1 and second integrated time IT2 obtained by the process indicated in the flowchart of FIG. 3. For example, the process indicated in the flowchart of FIG. 6 is interruptedly executed at given time intervals by control apparatus 13.

In step S301, control apparatus 13 reads the latest calculated values of oxygen storage capacity OSC, first integrated time IT1 and second integrated time IT2, stored in RAM 28.

Next, in step S302, control apparatus 13 determines whether second integrated time IT2 exceeds second time THT2 (for example, THT2=1100 hours to 1500 hours).

When second integrated time IT2 exceeds second time THT2, that is, when the total operating time at the catalyst temperature at which oxidation poisoning progresses exceeds a criterion time, control apparatus 13 estimates that oxidation poisoning of exhaust gas purification catalyst 12 progresses to the extent that the regeneration treatment of oxidation poisoning is necessary, in other words, control apparatus 13 estimates that the amount of oxygen left adsorbed on exhaust gas purification catalyst 12 exceeds an allowable maximum amount.

Then, when second integrated time IT2 exceeds second time THT2, control apparatus 13 proceeds to step S303, in which control apparatus 13 has the regeneration treatment of oxidation poisoning carried out for only a predetermined time TC2.

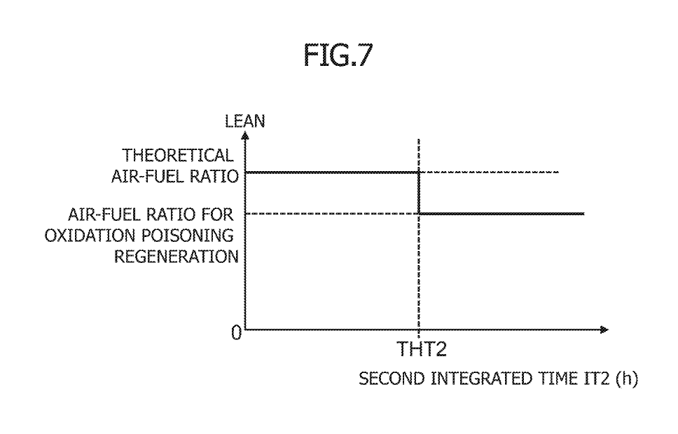

As the regeneration treatment of oxidation poisoning, control apparatus 13 controls the air-fuel ratio (average air-fuel ratio) of internal combustion engine 1 to a target air-fuel ratio for oxidation poisoning regeneration (for example, target air-fuel ratio=about 14.55 to 14.40), which is slightly richer than the theoretical air-fuel ratio, when temperature TCAT of exhaust gas purification catalyst 12 is in a temperature range exceeding oxidation criterion temperature OCTHT (see FIG. 7).

The slightly richer air-fuel ratio of internal combustion engine 1 than the theoretical air-fuel ratio causes exhaust gas purification catalyst 12 to be exposed to the reducing atmosphere at a high temperature. This leads to removal of oxygen that is adsorbed on the noble metal of exhaust gas purification catalyst 12, resulting in recovery from oxidation poisoning.

Criterion temperature OCTHT is the lowest temperature in a temperature range in which recovery from oxidation poisoning can be achieved within a predetermined time by making the air-fuel ratio slightly richer. For example, criterion temperature OCTHT may be the same as second temperature TCAT2 (TCAT2=700° C. to 800° C.), or may be a temperature near second temperature TCAT2.

Furthermore, when temperature TCAT of exhaust gas purification catalyst 12 falls below criterion temperature OCTHT during the oxidation poisoning regeneration treatment, control apparatus 13 temporarily stops the oxidation poisoning regeneration treatment, and thereafter, when temperature TCAT of exhaust gas purification catalyst 12 exceeds criterion temperature OCTHT, control apparatus 13 restarts the oxidation poisoning regeneration treatment. Then, when the total time of carrying out the oxidation poisoning regeneration treatment reaches predetermined time TC2, control apparatus 13 terminates the oxidation poisoning regeneration treatment.

Control apparatus 13 has the regeneration treatment of oxidation poisoning carried out in step S303, and in the next step S304, control apparatus 13 resets second integrated time IT2 to zero.

It should be noted that control apparatus 13 may be configured such that control apparatus 13 resets second integrated time IT2 to zero at the time of initiation of the oxidation poisoning regeneration treatment, and stops the integration of second integrated time IT2 until the oxidation poisoning regeneration treatment is completed to maintain second integrated time IT2 to zero, and then, restarts the integration of second integrated time IT2 after the completion of the oxidation poisoning regeneration treatment.

Furthermore, control apparatus 13 may be configured such that control apparatus 13 resets second integrated time IT2 to zero at the time of completion of the oxidation poisoning regeneration treatment, and updates second integrated time IT2 in accordance with a time period passing from the reset.

As in the foregoing, control apparatus 13 has the oxidation poisoning regeneration treatment carried out, when second integrated time IT2, which is the total operating time of internal combustion engine 1 under the temperature condition in which temperature TCAT of exhaust gas purification catalyst 12 is higher than second temperature TCAT2, exceeds second time THT2. Then, when the oxidation poisoning regeneration treatment is completed, control apparatus 13 integrates second integrated time IT2 again from zero.

This makes the oxidation poisoning regeneration treatment carried out every time exhaust gas purification catalyst 12 being in a state requiring recovery from oxidation poisoning, so that it is possible to prevent exhaust gas purification catalyst 12 from remaining in the oxidation poisoned state, and thus, it is possible to prevent the decline in exhaust gas purification performance.

In step S305, control apparatus 13 determines whether first integrated time IT1 exceeds first time THT1.

When first integrated time IT1 exceeds first time THT1, that is, when the total operating time at the catalyst temperature at which sulfur poisoning progresses exceeds a criterion time, there is a possibility that sulfur poisoning of exhaust gas purification catalyst 12 progresses to the extent that sulfur poisoning regeneration treatment is necessary.

However, first integrated time IT1 reaches first time THT1 more rapidly than second integrated time IT2 reaches second time THT2, and sulfur poisoning does not uniformly progress as first integrated time IT1 increases, so that there is a variation in the relationship between first integrated time IT1 and the progress degree of sulfur poisoning.

Thus, if it is configured such that the sulfur poisoning regeneration treatment is carried out every time first integrated time IT1 reaches first time THT1, there is a possibility that sulfur poisoning regeneration will be frequently unnecessarily carried out, and thus, this might adversely affect the fuel economy performance, etc., of internal combustion engine 1.

Therefore, in order to more accurately determine the necessity of sulfur poisoning regeneration treatment, when first integrated time IT1 exceeds first time THT1, control apparatus 13 proceeds to step S306, in which control apparatus 13 determines whether oxygen storage capacity OSC of exhaust gas purification catalyst 12 is less than first capacity OSC1.

If exhaust gas purification catalyst 12 is sulfur poisoned, sulfur (SOx compound) attached to the catalyst surface reduces the noble metal surface area of exhaust gas purification catalyst 12, so that oxygen storage capacity OSC of exhaust gas purification catalyst 12 decreases compared to that before it is sulfur poisoned. Thus, when the total operating time at the catalyst temperature at which sulfur poisoning progresses exceeds a criterion time and oxygen storage capacity OSC has decreased, control apparatus 13 determines that there is a need for the sulfur poisoning regeneration treatment, and proceeds to step S307.

In step S307, control apparatus 13 has the sulfur poisoning regeneration treatment carried out for only a predetermined time TC1.

As the regeneration treatment of sulfur poisoning, control apparatus 13 controls temperature TCAT of exhaust gas purification catalyst 12 to increase to poisoning regeneration treatment temperature SPCT or more. This temperature control causes detachment of sulfur attached to the surface of the noble metal of exhaust gas purification catalyst 12.

Poisoning regeneration treatment temperature SPCT is the lowest temperature in a temperature range in which sulfur integrated in exhaust gas purification catalyst 12 can be removed. For example, poisoning regeneration treatment temperature SPCT may be the same temperature as first temperature TCAT1 (TCAT1=750° C. to 850° C.), or may be a temperature near first temperature TCAT1.

It is known that, regardless of whether rich or lean of the air-fuel ratio of internal combustion engine 1 with respect to the theoretical air-fuel ratio, sulfur adhering to the noble metal of exhaust gas purification catalyst 12 detaches in such a high temperature state that temperature TCAT of exhaust gas purification catalyst 12 exceeds 700° C. (see JP 2012-057576 A, etc.). Thus, control apparatus 13 increases temperature TCAT of exhaust gas purification catalyst 12 to such a temperature condition as to achieve recovery from the sulfur poisoning in a short time.

In a temperature range lower than the temperature condition in which sulfur of exhaust gas purification catalyst 12 detaches regardless of whether rich or lean of the air-fuel ratio, sulfur detaches from exhaust gas purification catalyst 12 when the air-fuel ratio is lean with respect to the theoretical air-fuel ratio, and sulfur detaches in a shorter time as the air-fuel ratio is leaner.

Thus, as the sulfur poisoning regeneration treatment, control apparatus 13 may execute a control for making the average air-fuel ratio of internal combustion engine 1 leaner than theoretical air-fuel ratio, together with the control of temperature TCAT of exhaust gas purification catalyst 12.

As the process to increase temperature TCAT of exhaust gas purification catalyst 12 to be higher than or equal to poisoning regeneration treatment temperature SPCT, control apparatus 13 may execute various types of known processing, or may perform at least one of processes for making air-fuel ratio richer, correcting the ignition timing to be retarded, stopping the exhaust gas recirculation, increasing the engine revolution speed, increasing the intake air flow rate, and changing the valve timing, for example, to increase the exhaust gas temperature of internal combustion engine 1, to thereby increase temperature TCAT of exhaust gas purification catalyst 12.

Control apparatus 13 may change the transmission gear ratio of the transmission that is combined with the internal combustion engine in the vehicle to be low in order to increase the engine revolution speed.

Furthermore, a heater for heating exhaust gas purification catalyst 12 may be provided, and control apparatus 13 may operate the heater as the regeneration treatment of sulfur poisoning, so that the heating by the heater makes temperature TCAT of exhaust gas purification catalyst 12 increased to poisoning regeneration treatment temperature SPCT or more.

If the fuel cutoff, which causes first integrated time IT1 to be reset to zero in step S208 as described above, is executed during the regeneration treatment of sulfur poisoning, control apparatus 13 determines that poisoning regeneration has been completed due to the fuel cutoff, and terminates the regeneration treatment of sulfur poisoning.

Control apparatus 13 has the regeneration treatment of sulfur poisoning carried out in step S307, and resets first integrated time IT1 to zero in the next step S308.

It should be noted that control apparatus 13 may be configured such that control apparatus 13 resets first integrated time IT1 to zero at the time of initiation of the sulfur poisoning regeneration treatment, and stops the integration of first integrated time IT1 until the sulfur poisoning regeneration treatment is completed to maintain first integrated time IT1 to zero, and then, restarts the integration of first integrated time IT1 after the completion of the sulfur poisoning regeneration treatment.

Furthermore, control apparatus 13 may be configured such that control apparatus 13 resets first integrated time IT1 to zero at the time of completion of the sulfur poisoning regeneration treatment, and integrates first integrated time IT1 in accordance with a time period passing from the reset.

On the other hand, when control apparatus 13 determines in step S306 that oxygen storage capacity OSC of exhaust gas purification catalyst 12 is greater than or equal to first capacity OSC1, control apparatus 13 bypasses step S307 (sulfur poisoning regeneration treatment) and proceeds to step S308, in which control apparatus 13 resets first integrated time IT1 to zero.

Even though first integrated time IT1, which is the total operating time under the temperature condition under which sulfur poisoning of exhaust gas purification catalyst 12 progresses, exceeds first time THT1 and indicates a possibility that sulfur poisoning has occurred, if oxygen storage capacity OSC has not decreased to the level at which the occurrence of sulfur poisoning is estimated, control apparatus 13 assumes that sulfur poisoning has not actually occurred to the extent that a regeneration treatment is necessary, and control apparatus 13 does not have a sulfur poisoning regeneration treatment carried out.

It should be noted that control apparatus 13 may be configured such that, when control apparatus 13 determines in step S306 that oxygen storage capacity OSC of exhaust gas purification catalyst 12 is greater than or equal to first capacity OSC1, control apparatus 13 does not reset first integrated time IT1 to zero, but makes first integrated time IT1 shifted to a time that is shorter than first time THT and longer than zero, to have first integrated time IT1 reach first time THT1 in a shorter operating time than when resetting first integrated time IT1 to zero, so as to determine whether or not oxygen storage capacity OSC has declined.

In other words, when first integrated time IT1 reaches first time THT1 from zero, there is a possibility that sulfur poisoning has progressed to some extent even though sulfur poisoning does not progress to the extent that sulfur poisoning regeneration treatment is necessary, and there is a possibility that, if the necessity of sulfur poisoning regeneration treatment is not determined until first integrated time IT1 reaches first time THT1 from zero, exhaust gas purification catalyst 12 remains poisoned despite sulfur poisoning regeneration treatment being necessary.

Thus, when first integrated time IT1 exceeds first time THT1, but oxygen storage capacity OSC has not decreased to the level at which the occurrence of sulfur poisoning is estimated, control apparatus 13 changes and shortens the operation time until the next determination of whether oxygen storage capacity OSC is less than first capacity OSC1, to prevent exhaust gas purification catalyst 12 from remaining poisoned by the absence of regeneration treatment despite sulfur poisoning progressing to the level at which regeneration treatment is necessary.

Control apparatus 13 individually determines whether oxidation poisoning and sulfur poisoning have occurred and has the poisoning regeneration treatments carried out, as described above, and moreover, in step S309, control apparatus 13 determines whether oxygen storage capacity OSC is less than second capacity OSC2 (first capacity OSC1>second capacity OSC2).

Second capacity OSC2 is a threshold value for determining whether or not decline in purification performance of exhaust gas purification catalyst 12 exceeds an allowable level. When oxygen storage capacity OSC is less than second capacity OSC2, control apparatus 13 estimates that the purification performance of exhaust gas purification catalyst 12 has declined beyond the allowable level.

For example, when an off-grade fuel with high sulfur concentration is used as the fuel of internal combustion engine 1, or when misfire occurs under high temperature TCAT of exhaust gas purification catalyst 12, sulfur poisoning or oxidation poisoning will progress more rapidly than the standard rate of progress estimated from the integration of operating time. Therefore, control apparatus 13 cannot detect the occurrence of poisoning in good response based on first integrated time IT1 and second integrated time IT2.

However, when sulfur poisoning and/or oxidation poisoning progresses suddenly, this will cause a sudden decrease in oxygen storage capacity OSC. Thus, control apparatus 13 can detect a sudden decrease in oxygen storage capacity OSC caused by poisoning, based on the fact that oxygen storage capacity OSC is less than second capacity OSC2.

However, since the decrease in oxygen storage capacity OSC occurs due to both sulfur poisoning and oxidation poisoning, control apparatus 13 cannot distinguish which of sulfur poisoning and oxidation poisoning causes oxygen storage capacity OSC to be lower than second capacity OSC2.

Thus, when oxygen storage capacity OSC is less than second capacity OSC2 and recovery of oxygen storage capacity OSC is necessary, control apparatus 13 proceeds to step S310, in which control apparatus 13 has both sulfur poisoning regeneration treatment and oxidation poisoning regeneration treatment carried out.

That is, control apparatus 13 performs, in step S310, a control for increasing temperature TCAT of exhaust gas purification catalyst 12 to poisoning regeneration treatment temperature SPCT or more, when temperature TCAT of exhaust gas purification catalyst 12 is lower than poisoning regeneration treatment temperature SPCT. Furthermore, control apparatus 13 performs a control for making the air-fuel ratio of internal combustion engine 1 slightly richer, when temperature TCAT of exhaust gas purification catalyst 12 is in the temperature range exceeding oxidation criterion temperature OCTHT.

In a case in which the control for increasing temperature TCAT of exhaust gas purification catalyst 12 to poisoning regeneration treatment temperature SPCT or more is the control for increasing temperature TCAT of exhaust gas purification catalyst 12 to the temperature at which sulfur is removed regardless of whether the air-fuel ratio is rich or lean, the sulfur poisoning regeneration treatment and the oxidation poisoning regeneration treatment are simultaneously carried out by carrying out the air-fuel ratio control that makes the air-fuel ratio slightly richer while performing the temperature control.

Furthermore, in a case in which the sulfur poisoning regeneration treatment includes the air-fuel ratio control that makes the air-fuel ratio leaner than theoretical air-fuel ratio, since a shifting direction of the air-fuel ratio is opposite to that in the enriching treatment in the oxidation poisoning regeneration treatment, control apparatus 13 preferentially carries out either of the treatment to make leaner, serving as the sulfur poisoning regeneration treatment, and the treatment to make richer, serving as the oxidation poisoning regeneration treatment, and then carries out the remaining air-fuel ratio treatment.

For example, among the sulfur poisoning regeneration treatment that makes the air-fuel ratio leaner and the oxidation poisoning regeneration treatment that makes the air-fuel ratio slightly richer, control apparatus 13 may preferentially carry out one requiring shorter time for poisoning regeneration. By adopting such a configuration, it is possible to promptly recover oxygen storage capacity OSC of exhaust gas purification catalyst 12.

In step S310, control apparatus 13 has both the sulfur poisoning regeneration treatment and the oxidation poisoning regeneration treatment carried out, to recover from both sulfur poisoning and oxidation poisoning. Thus, in the next step S311, control apparatus 13 resets first integrated time IT1 and second integrated time IT2 to zero, to allow progress of sulfur poisoning and oxidation poisoning after the poisoning regeneration treatments in step S310 to be detected based on first integrated time IT1 and second integrated time IT2.

It should be noted that control apparatus 13 may employ the rate of decrease in oxygen storage capacity OSC in the determination as the proceeding condition from step S309 to step S310. For example, control apparatus 13 may proceed from step S309 to step S310 and then has sulfur poisoning regeneration treatment and oxidation poisoning regeneration treatment carried out, when the rate of decrease in oxygen storage capacity OSC with respect to the operating time of internal combustion engine 1 exceeds a criterion speed, or when oxygen storage capacity OSC is less than first capacity OSC1 and the rate of decrease exceeds the criterion speed.

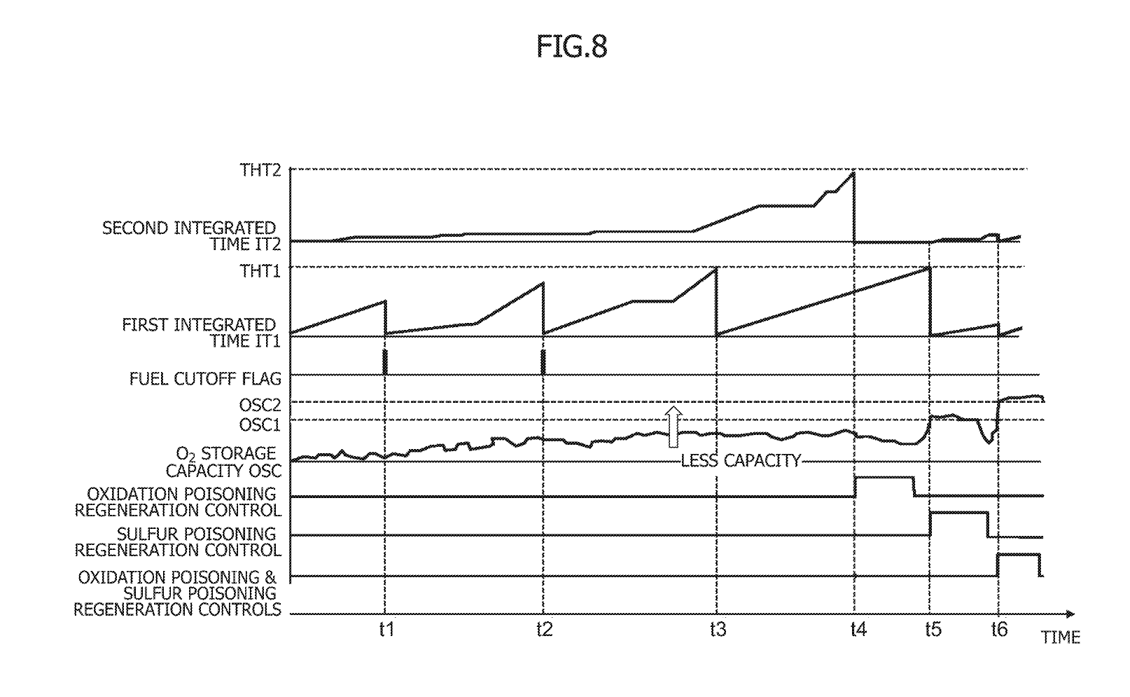

FIG. 8 is a timing diagram illustrating the process of carrying out the oxidation poisoning regeneration treatment and the sulfur poisoning regeneration treatment by control apparatus 13.

In the timing diagram of FIG. 8, a fuel cutoff flag is a flag that is generated when the fuel cutoff is executed for predetermined time FCT or more in a state in which temperature TCAT of exhaust gas purification catalyst 12 is higher than criterion temperature SCTHT. When the fuel cutoff flag is generated, the process in the flowchart of FIG. 3 proceeds from step S207 to step S208.

At time t1 and time t2 of the timing diagram of FIG. 8, although first integrated time IT1 for determining the progress of sulfur poisoning has not reached first time THT1, the fuel cutoff flag is generated. The generation of fuel cutoff flag indicates that the fuel cutoff has been executed for predetermined time FCT or more in a state in which temperature TCAT of exhaust gas purification catalyst 12 is higher than criterion temperature SCTHT. Since the fuel cutoff causes the removal of sulfur integrated in exhaust gas purification catalyst 12, control apparatus 13 resets first integrated time IT1 to zero.

The resetting process of first integrated time IT1 to zero corresponds to a pattern proceeding from step S207 to step S208 in FIG. 3.

Furthermore, at time t3 of the timing diagram of FIG. 8, although first integrated time IT1 has reached first time THT1 and first integrated time IT1 is in the level in which the sulfur poisoning regeneration treatment is necessary, oxygen storage capacity OSC of exhaust gas purification catalyst 12 at that time is greater than first capacity OSC1, and thus, the noble metal area of exhaust gas purification catalyst 12 is not reduced to a predetermined extent or more due to sulfur poisoning. Therefore, at time t3, control apparatus 13 resets first integrated time IT1 to zero without carrying out the sulfur poisoning regeneration treatment.

This resetting process of first integrated time IT1 to zero corresponds to a pattern proceeding from step S306 to step S308 in FIG. 6.

On the other hand, at time t4 in the timing diagram of FIG. 8, the second integrated time IT2 has reached second time THT2, and this indicates that oxidation poisoning of the exhaust gas purification catalyst 12 progresses to the extent that the oxidation poisoning regeneration treatment is necessary. Therefore, control apparatus 13 has the oxidation poisoning regeneration treatment carried out and resets second integrated time IT2 to zero.

The processes of having the oxidation poisoning regeneration treatment carried out and of resetting second integrated time IT2 to zero correspond to a pattern proceeding from step S302 to step S303 and step S304 in FIG. 6.

Also, at time t5 in the timing diagram of FIG. 8, since first integrated time IT1 has reached first time THT1, and oxygen storage capacity OSC at that time is less than first capacity OSC1, control apparatus 13 estimates that the noble metal area of exhaust gas purification catalyst 12 has been reduced to a predetermined value or less due to sulfur poisoning, in other words, estimates that removal of sulfur from exhaust gas purification catalyst 12 is necessary, and thus, control apparatus 13 has the sulfur poisoning regeneration treatment carried out and resets first integrated time IT1 to zero.

The processes of having the sulfur poisoning regeneration treatment carried out and of resetting first integrated time IT1 to zero correspond to a pattern proceeding from step S306 to step S307 and step S308 in FIG. 6.

Furthermore, at time t6 of the timing diagram of FIG. 8, first integrated time IT1 is less than first time THT1 and second integrated time IT2 is less than second time THT2, and thus, first integrated time IT1 and second integrated time IT2 do not indicate the occurrence of sulfur poisoning and oxidation poisoning in exhaust gas purification catalyst 12; however, oxygen storage capacity OSC of exhaust gas purification catalyst 12 is less than second capacity OSC2 (second capacity OSC2<first capacity OSC1).

In this case, it can be estimated that sudden poisoning that progresses rapidly compared to sulfur poisoning and oxidation poisoning estimated from first integrated time IT1 and second integrated time IT2, has occurred due to the use of fuel with high sulfur concentration or misfiring at high temperatures, for example. Thus, control apparatus 13 has the oxidation poisoning regeneration treatment and the sulfur poisoning regeneration treatment carried out, and resets first integrated time IT1 and second integrated time IT2 to zero.

The process of having the oxidation poisoning regeneration treatment and the sulfur poisoning regeneration treatment carried out and of resetting first integrated time IT1 and second integrated time IT2 to zero correspond to a pattern proceeding from step S309 to step S310 and step S311 in FIG. 6.

The contents of the invention have been described in detail above with reference to the preferred embodiment, but it is apparent that one skilled in the art can make various types of modifications based on the basic technical concept and teachings of the invention.

For example, depending on whether oxygen storage capacity OSC at the time when first integrated time IT1 reaches first time THT1 exceeds or is less than first capacity OSC1, control apparatus 13 may change the total operating time until first integrated time IT1 reaches first time THT1 at the next time.

That is, when oxygen storage capacity OSC at the time when first integrated time IT1 reaches first time THT1 is less than first capacity OSC1, control apparatus 13 estimates that the progress of the sulfur poisoning in association with first integrated time IT1 is more rapid than that expected, and decreases first time THT1 or increases integration coefficient ICO1, so as to shorten the total operating time until first integrated time IT1 reaches first time THT1 at the next time. This makes it possible to improve detection responsiveness to sulfur poisoning.

On the other hand, when oxygen storage capacity OSC at the time when first integrated time IT1 reaches first time THT1 exceeds first capacity OSC1, control apparatus 13 estimates that the progress of sulfur poisoning in association with first integrated time IT1 is slower than that expected, and increases first time THT1 or decreases integration coefficient ICO1, so as to lengthen the total operating time until first integrated time IT1 reaches first time THT1 at the next time IT. This makes it possible to have the determination cycle of sulfur poisoning more appropriate.

Furthermore, when controlling apparatus 13 senses oxygen storage capacity OSC being less than second capacity OSC2, and has the sulfur poisoning regeneration treatment and the oxidation poisoning regeneration treatment carried out, there is a possibility that fuel with sulfur concentration higher than specified is used, and thus, the control apparatus may decrease first time THT1 or increase integration coefficient ICOL so as to shorten the determination cycle of sulfur poisoning to adapt the cycle to the rapid progress of sulfur poisoning.

Furthermore, control apparatus 13 may switch first time THT1 and/or the integration coefficient ICO1 in accordance with the characteristics correlating with the sulfur concentration of the gasoline fuel used in internal combustion engine 1, for example, in accordance with a determination result of whether it is high octane gasoline or regular gasoline, so as to change the determination cycle of sulfur poisoning.

### REFERENCE SYMBOL LIST

1 Internal combustion engine
4 Ignition device
5 Fuel injection device
6 Revolution speed sensing device
8 Electric throttle
8c Throttle opening sensor
9 Flow rate sensing device
11 Air-fuel ratio sensor
12 Exhaust gas purification catalyst
13 Control apparatus
15 Oxygen sensor
16 Exhaust gas temperature sensor

1. A control apparatus for an internal combustion engine provided with an exhaust gas purification catalyst in an exhaust pipe, comprising:
a first integration section that integrates an operating time of the internal combustion engine operated in a state in which a temperature of the exhaust gas purification catalyst is lower than a first temperature, to obtain a first integrated time;
a capacity sensing section that senses an oxygen storage capacity of the exhaust gas purification catalyst;
a first poisoning detection section that detects poisoning of the exhaust gas purification catalyst, when the first integrated time exceeds a first time and the oxygen storage capacity falls below a first capacity; and
a first poisoning regeneration section that carries out a poisoning regeneration treatment that increases the temperature of the exhaust gas purification catalyst, when the first poisoning detection section detects the poisoning of the exhaust gas purification catalyst.

2. The control apparatus for an internal combustion engine, according to claim 1, further comprising:
a second integration section that integrates an operating time of the internal combustion engine operated in a state in which a temperature of the exhaust gas purification catalyst is higher than a second temperature, to obtain a second integrated time;
a second poisoning detection section that detects poisoning of the exhaust gas purification catalyst, when the second integrated time exceeds a second time; and
a second poisoning regeneration section that carries out a poisoning regeneration treatment that changes an air-fuel ratio of the internal combustion engine to be richer, when the second poisoning detection section detects the poisoning of the exhaust gas purification catalyst.

3. The control apparatus for an internal combustion engine, according to claim 1, wherein at least one of the first integration section and the second integration section weights the operating time in accordance with the temperature of the exhaust gas purification catalyst within a temperature range of the exhaust gas purification catalyst in which the operating time is integrated.

4. The control apparatus for an internal combustion engine, according to claim 3, wherein the first integration section decreases weight of the operating time as the temperature of the exhaust gas purification catalyst is closer to the first temperature, and the second integration section decreases weight of the operating time as the temperature of the exhaust gas purification catalyst is closer to the second temperature.

5. The control apparatus for an internal combustion engine, according to claim 1, further comprising:
a third poisoning regeneration section that carries out the poisoning regeneration treatment that increases the temperature of the exhaust gas purification catalyst and a poisoning regeneration treatment that changes an air-fuel ratio of the internal combustion engine to be richer, when the oxygen storage capacity falls below a second capacity that is less than the first capacity.

6. The control apparatus for an internal combustion engine, according to claim 1, wherein the first integration section clears the first integrated time, when fuel supply to the internal combustion engine is stopped at a temperature of the exhaust gas purification catalyst that is higher than the first temperature.

7. A control method for an internal combustion engine provided with an exhaust gas purification catalyst in an exhaust pipe, comprising:
integrating an operating time of the internal combustion engine operated in a state in which a temperature of the exhaust gas purification catalyst is lower than a first temperature, to obtain a first integrated time;
sensing an oxygen storage capacity of the exhaust gas purification catalyst; and
carrying out a poisoning regeneration treatment that increases the temperature of the exhaust gas purification catalyst, when the first integrated time exceeds a first time and the oxygen storage capacity falls below a first capacity.

8. The control method for an internal combustion engine, according to claim 7, further comprising:
integrating an operating time of the internal combustion engine operated in a state in which a temperature of the exhaust gas purification catalyst is higher than a second temperature, to obtain a second integrated time; and
carrying out a poisoning regeneration treatment that changes an air-fuel ratio of the internal combustion engine to be richer, when the second integrated time exceeds a second time.
